(19) United States
(12) Patent Application Publication
(10) Pub. No.: US 2025/0298657 A1
(43) Pub. Date: Sep. 25, 2025

(54) TASK ASSIGNMENT IN HETEROGENEOUS MULTI-CHIPLET PROCESSORS

(71) Applicant: ADVANCED MICRO DEVICES, INC., Santa Clara, CA (US)

(72) Inventors: Mahmoud Khairy Abdelsadek Abdallah, Santa Clara, CA (US); Michael W. Boyer, Redmond, WA (US); Nuwan S. Jayasena, Santa Clara, CA (US); Sooraj Puthoor, Austin, TX (US)

(21) Appl. No.: 18/612,505

(22) Filed: Mar. 21, 2024

(51) Int. Cl. G06F 9/48; G06F 9/54; G06F 15/80

(52) U.S. Cl. CPC G06F 9/4881; G06F 9/544; G06F 15/80

(57) ABSTRACT

Efficient task assignment is provided in heterogeneous multi-chiplet processors including one or more advanced processing chiplets (APCs) and one or more central processing chiplets (CPCs). A graphics processing unit (GPU) assigns data for use by one or more tasks to memories associated with a plurality of APCs and one or more CPCs. A scheduler or other controller within or otherwise associated with the GPU assigns tasks, which utilize the assigned data, to the APCs and one or more CPCs as appropriate. The scheduler is configured to assign the tasks to the plurality of APCs such that at least one task associated with data assigned to the at least one CPC is assigned to at least one of the plurality of APCs and optimizes correspondence between data associated with the tasks that is assigned to memories associated with the plurality of APCs and the tasks assigned to the plurality of APCs.

### BACKGROUND

Parallel processors such as accelerator processors and graphics processing units (GPUs) conventionally implement graphics processing pipelines that concurrently process copies of commands that are retrieved from a command buffer. GPUs and other multithreaded processing units typically implement multiple processing elements (which may include processor cores, compute units, chiplets, or workgroup processors) that execute different programs or concurrently execute multiple instances of a single program on multiple data sets as a single “wave,” i.e., a group of threads running concurrently on a GPU. A hierarchical execution model is typically used to match the hierarchy implemented in hardware.

The execution model defines a kernel of instructions that are executed by one or more waves (also referred to as wavefronts, which may include one or more threads, streams, tasks, or work items). The graphics pipeline in a conventional GPU includes one or more shader engines that execute computer programs typically referred to as “shaders” using resources of the graphics pipeline such as compute units, memory, and caches. GPUs are traditionally used for graphical calculations, as implied by their name; however, in modern computing, shaders are often utilized as “compute shaders,” which function as general-purpose software that is able to perform work separately from a graphics processing pipeline. As GPU usage and machine learning applications have expanded over time, there is a necessity to improve the functionality and performance of GPUs.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system providing efficient task assignment in a heterogeneous multi-chiplet processor according to some implementations.

FIG. 2 is a block diagram illustrating an example of efficient task assignment in a homogeneous multi-chiplet processor according to some implementations.

FIG. 3 is a block diagram illustrating an example of inefficient task assignment in a heterogeneous multi-chiplet processor according to some implementations.

FIG. 4 is a block diagram illustrating an example of efficient task assignment in a heterogeneous multi-chiplet processor according to some implementations.

FIG. 5 is a block diagram illustrating another example of efficient task assignment in a heterogeneous multi-chiplet processor according to some implementations.

FIG. 6 is a block diagram illustrating yet another example of efficient task assignment in a heterogeneous multi-chiplet processor according to some implementations.

FIG. 7 is a flow diagram of a method of providing efficient task assignment in heterogeneous multi-chiplet processors according to some implementations.

### DETAILED DESCRIPTION

A parallel processor such as an accelerated processing device or graphics processing unit (GPU) typically includes a plurality of “shader engines,” where each shader engine includes a respective quantity of compute units, and a command processor coupled to the plurality of shader engines. Based on one or more commands received for execution, a plurality of workgroups or tasks (e.g., processing threads or collections of threads corresponding to one or more programs) is generated for assignment to the plurality of shader engines for processing. The command processor receives one or more commands for execution and generates the plurality of workgroups based on the one or more commands. Assigning each workgroup to a respective shader engine may include dynamically assigning each workgroup to a respective shader engine via an interface such as a shader program interface (SPI), which acts as a scheduler, associated with the respective shader engine.

However, as GPU usage for executing compute shaders, machine learning applications, and other general-purpose applications has expanded over time, in order to provide a GPU with the flexibility to execute tasks related to a graphics processing pipeline, machine learning, or other advanced computing applications in an efficient manner, GPUs implemented in accordance with the teachings of the present disclosure are provided with a plurality of advanced processing chiplets (APCs), also referred to as parallel processing chiplets (PPCs), which are configured to process tasks and function as advanced GPU chiplets in that they offer one or more of parallel processing functionality, optimized GPU functionality, and optimized processing for advanced applications that utilize, e.g., reduced precision data common in machine learning, and one or more central processing chiplets (CPCs), which function similarly to a traditional central processing unit (CPU). The APCs and one or more CPCs are able to execute instructions separately or in parallel and, in some implementations, share a single pool of virtual and physical memory with extremely low latency. By providing a GPU with a plurality of APCs and one or more CPCs, the GPU is able to function as either or both of a GPU and a CPU, while latency and data transfer energy between the APCs and one or more CPCs is minimized. In some implementations, the APCs and CPCs each include one or more sub-chiplets or other components, such as sub-schedulers and compute units, which are managed either by the GPU, a scheduler or controller within or otherwise associated with the GPU, or manually by a user.

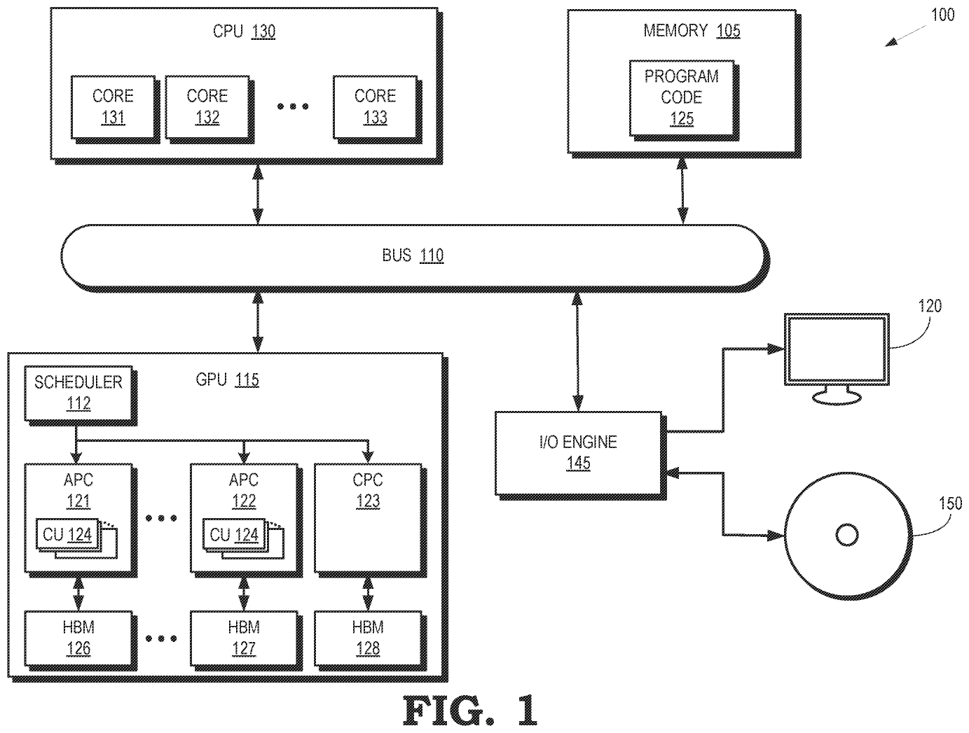

FIGS. 1 and 4-7 illustrate systems and techniques for providing efficient task assignment in heterogeneous multi-chiplet processors. As described in detail hereinbelow, a multi-chip processor or GPU assigns data for use by one or more tasks to a shared memory or memories associated with a plurality of APCs and one or more CPCs. A scheduler or other controller within or otherwise associated with the GPU assigns threads or groups of threads, which utilize the assigned data, to the APCs and one or more CPCs as appropriate. However, the CPCs are typically not capable of performing advanced tasks, such as highly parallel or machine learning tasks, with high efficiency. Accordingly, such advanced tasks typically need to be assigned to the APCs and not the one or more CPCs in order to optimize performance.

Due to the assignment of the data required by the tasks to memories associated with the CPCs, and the less efficient performance of obtaining off-chiplet “remote” data (e.g., an APC accessing data stored in a memory associated with one or more other APCs or CPCs) compared to the performance of reading on-chiplet “local” data (e.g., an APC accessing data stored in its own memory or its own associated memory), which is typically lower latency and more energy efficient than reading off-chiplet data, assignment of tasks to the APCs should be optimized in order to minimize the necessity for APCs to access off-chiplet remote data. To provide this functionality, example implementations, apparatuses, and methods described hereinbelow provide efficient task assignment in heterogeneous multi-chiplet processors that include a plurality of APCs and one or more CPC.

FIG. 1 is a block diagram of a processing system 100 providing efficient task assignment in a heterogeneous multi-chiplet processor according to some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The techniques described herein are, in different implementations, employed at any of a variety of parallel processors (e.g., vector processors, GPUs, general-purpose GPUs (GPGPUs), non-scalar processors, highly parallel processors, artificial intelligence (AI) processors, inference engines, machine learning processors, other multithreaded processing units, and the like). FIG. 1 illustrates an example of a multi-chiplet processor, which is implemented in the illustrated example as GPU 115, in accordance with some implementations. The GPU 115 typically renders images for presentation on a display 120. For example, the GPU 115 renders objects to produce values of pixels that are provided to the display 120, which uses the pixel values to display an image that represents the rendered objects. However, the GPU 115 is also capable of executing software not directly involved in any graphics processing pipeline, such as machine learning applications and other advanced computing applications.

In order to provide the GPU 115 with the flexibility to execute tasks related to a graphics processing pipeline, machine learning, or other advanced computing applications in an efficient manner, the GPU 115 includes a plurality of APCs, such as APCs 121, 122, which are configured to process tasks and function as advanced GPU chiplets in that they offer one or more of GPU functionality and optimized processing for advanced applications that utilize, e.g., reduced precision data common in machine learning, and a CPC 123, which functions similarly to a traditional CPU, enabling arithmetic and other operations, and typically lacks at least some functionality included in APCs. The APCs 121, 122 and CPC 123 are able to execute instructions separately or in parallel and, in some implementations, share a single pool of virtual and physical memory with extremely low latency. By providing the GPU 115 with a plurality of APCs 121, 122 and a CPC 123, the GPU 115 is configurable to function as either or both of a GPU and a CPU, while latency and data transfer energy between the APCs 121, 122 and CPC 123 is minimized. The APCs 121, 122 are typically implemented using shared hardware resources of the GPU 115, such as compute units 124. In some implementations, the APCs 121, 122 are used to implement shaders, such as geometry shaders, pixel shaders, and the like. Generally, the APCs 121, 122 are a logical grouping of processing hardware, which in some implementations includes, e.g., one or more processing chiplets or processor cores, and/or caches. The APCs 121, 122 typically include or access a number of compute units 124 in the GPU 115, and each of the compute units 124 typically includes a number of single-instruction-multiple-data (SIMD) units. The number of APCs 121, 122 and CPCs 123 implemented in the GPU 115 is a matter of design choice and some implementations of the GPU 115 include more or fewer APCs and/or CPCs 123 than are shown in FIG. 1.

As shown in FIG. 1, the GPU 115 further includes a scheduler 112, which is implemented as any cooperating collection of hardware, software, or a combination thereof that performs functions and computations associated with assigning threads, workgroups, waves, or other tasks, such as compute shader threads, to one or more of the APCs 121, 122 and the CPC 123. In some implementations, one or more of the APCs 121, 122 and the CPC 123 are able to be selectively addressed or controlled independently from one another or addressed or controlled in groups of two or more such that the GPU 115, the scheduler 112, and/or a user is able to control which APCs 121, 122 and CPC 123 perform specific tasks or to distribute tasks across a number of APCs 121, 122 and CPC 123. In some implementations, the GPU 115 is used for general purpose computing. The GPU 115 executes instructions such as program code 125 stored in the memory 105 and the GPU 115 stores information in the memory 105 such as the results of the executed instructions.

As described further hereinbelow, in order to provide efficient task assignment in a heterogeneous multi-chiplet processor such as the GPU 115, the GPU 115 is configured to assign data associated with tasks to memories, e.g., high-bandwidth memories (HBMs) 126, 127, and 128, associated with, e.g., in close proximity to and/or sharing a chiplet with a respective one of, the plurality of APCs and the at least one CPC in a first assignment order, and the scheduler is configured to assign the tasks to the plurality of APCs in a second assignment order different from the first assignment order such that at least one task associated with data assigned to the at least one CPC is assigned to at least one of the plurality of APCs. Although the GPU 115 or a related controller will typically assign data to the HBMs 126, 127, and 128 and the scheduler 112 will typically assign tasks to the APCs 121, 122 and/or CPC 123, in some implementations, a user or program manually assigns data to the APCs 121, 122 and CPC 123 and tasks to the HBMs 126, 127, and 128, either directly or via the scheduler 112, as desired for a particular scenario in which the user or program is optimized to utilize the GPU 115 in a particular configuration.

In some implementations, the processing system 100 also includes a CPU 130 that is connected to the bus 110 and therefore communicates with the GPU 115 and the memory 105 via the bus 110. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some implementations include more or fewer processor cores than are illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics processing by issuing draw calls or other tasks to the GPU 115.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the GPU 115, or the CPU 130. In the illustrated implementation, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the GPU 115 or the CPU 130.

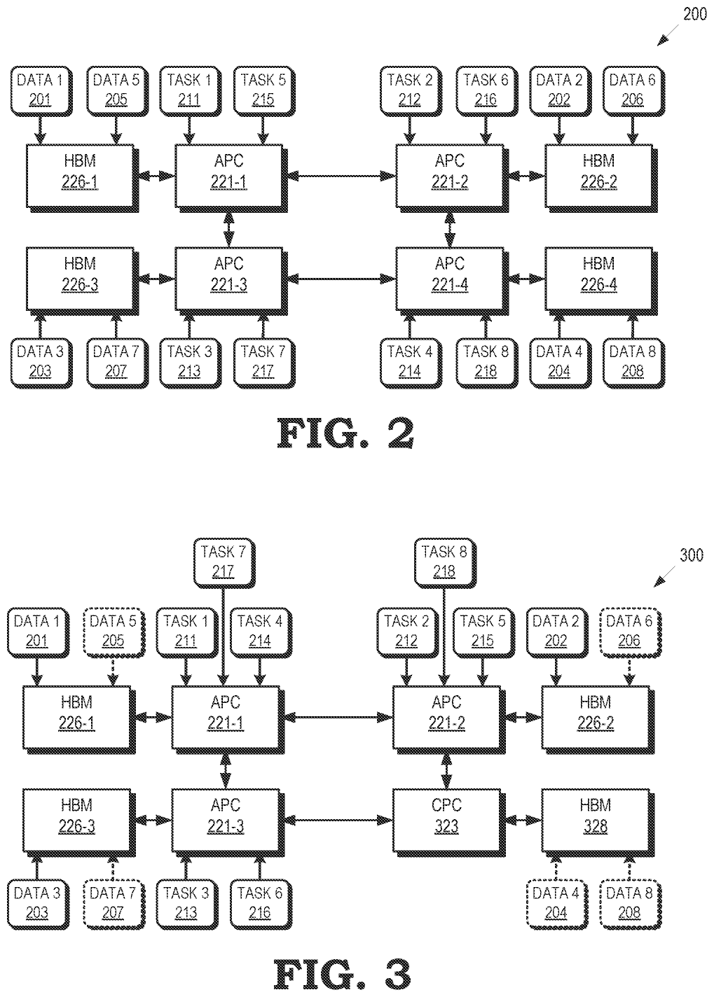

FIG. 2 is a block diagram 200 illustrating an example of efficient task assignment in a homogeneous multi-chiplet processor according to some implementations. For example, in a homogeneous multi-chiplet GPU including APCs 221-1, 221-2, 221-3, and 221-4 and no CPC, the GPU ensures efficient task assignment by interleaving data 201, 202, 203, 204, 205, 206, 207, and 208, collectively referred to herein as data 201-208, across each of the HBMs 226-1, 226-2, 226-3, and 226-4 that are associated with the APCs. Once the data 201-208 is assigned to the HBMs 226, a scheduler similar to scheduler 112 of FIG. 1 assigns tasks 211, 212, 213, 214, 215, 216, 217, and 218, collectively referred to herein as tasks 211-218, to the APCs 221 by interleaving the tasks 211-218 across each of the APCs 221 in the same order as the order in which the data 21-208 was assigned to the HBMs 226.

Notably, in this disclosure, the terms “order” or “assignment order” do not necessarily refer to a sequence in time but rather an order, or pattern, of assignments relative to the particular components. Accordingly, although, for example, data 7 207 may be assigned to HBM 226-3 prior to data 8 208 being assigned to HBM 226-4 while task 8 218 may be assigned to APC 221-4 prior to task 7 217 being assigned to APC 221-3, the “order” of the assignments of the data, in the context of this disclosure, would still match or correspond to the “order” or “pattern” of the assignments of the tasks in the example of diagram 200, as data 7 207 would at some point still be assigned to HBM 226-3 and data 8 208 would still be assigned to HBM 226-4 while task 7 217 is assigned to APC 221-3 and task 8 218 is assigned to APC 221-4. In other words, the “order” as described herein is analogous to the “pattern” of assignments relative to the components rather than the particular timing of the assignments. Notably, although the data 201-208 and the tasks 211-218 are assigned in a “Z” order in FIG. 2, such that, e.g., data 1 201 is assigned to HBM 226-1, data 2 202 is assigned to HBM 226-2, data 3 203 is assigned to HBM 226-3, data 4 204 is assigned to HBM 226-4, data 5 205 is assigned to HBM 226-1, and so on, in other implementations, other assignment orders are used, such as a round robin assignment order, such that, e.g., data 1 201 is assigned to HBM 226-1, data 2 202 is assigned to HBM 226-2, data 3 203 is assigned to HBM 226-4, data 4 204 is assigned to HBM 226-3, data 5 205 is assigned to HBM 226-1, and so on. In general, in some implementations, any desired assignment order, such as a “Z” order, a round robin order, or other order is usable.

As can be seen in FIG. 2, by assigning the data 201-208 and the tasks 211-218 in the same order across the APCs 221 and HBMs 226, the tasks and data associated with those tasks, e.g., task 1 211 and data 1 201, are assigned to a corresponding set of APC and HBM, i.e., APC 221-1 and HBM 226-1. Although, as indicated by the arrows between the APCs 221 in FIG. 2, the APCs 221 are capable of communicating between and among each other and of accessing data stored in any HBM attached to any APC, corresponding sets of APCs and HBMs, such as APC 221-1 and HBM 226-1, are able to utilize on-chiplet local traffic and thus require lower energy per bit and/or provide lower latency compared to off-chiplet remote traffic, such as would be required if, for example, data 1 201 were assigned to HBM 226-1 but task 1 211 were assigned to APC 221-2. Accordingly, assigning the data 201-208 and the tasks 211-218 in the same order across the APCs 221 and HBMs 226 ensures efficient task assignment in a homogeneous multi-chiplet processor like that illustrated in diagram 200.

FIG. 3 is a block diagram 300 illustrating an example of inefficient task assignment in a heterogeneous multi-chiplet processor like GPU 115 of FIG. 1 according to some implementations, where APCs 221, HBMs 226, CPC 323, and HBM 328 correspond generally to APCs 121, 122, HBMs 126, 127, CPC 123, and HBM 128, respectively. As shown in FIG. 3, illustrated by dashed lines indicating non-corresponding data 204, 205, 206, 207, and 208, using the same assignment order for the data 201-208 and the tasks 211-218 in a heterogeneous multi-chiplet processor like GPU 115 of FIG. 1 results in significant off-chiplet remote traffic, requiring higher energy per bit and/or causing higher latency compared to on-chiplet local traffic. While it will be appreciated that, in FIG. 3, the data 201-208 is assigned similarly to the data assignments of FIG. 2, i.e., data 1 201 and data 5 205 are assigned to HBM 226-1, data 2 202 and data 6 206 are assigned to HBM 226-2, etc., data 4 204 and data 8 208 are assigned to HBM 328, which does not correspond to one of the APCs 221. Instead, HBM 328 corresponds to the CPC 323. This is because, in order to utilize the full memory capacity of a heterogeneous multi-chiplet processor like GPU 115 of FIG. 1, in some implementations, even memory associated with CPC 323 is utilized to store data required for task processing. However, the CPC 323 is not capable of performing advanced or highly parallel tasks such as machine learning tasks with high efficiency. Accordingly, tasks that are assigned to APC 221-4 in the homogeneous processor example of FIG. 2 (i.e., tasks 214 and 218) cannot be assigned to the CPC 323 in the heterogeneous processor example of FIG. 3. As such, in some implementations, tasks 214 and 218 are assigned to other ones of the APCs 221.

However, assigning tasks 214 and 218 to other ones of the APCs 221 using a similar assignment order to that utilized in the example of FIG. 2 results in significant off-chiplet remote traffic, as noted above and illustrated by dashed lines indicating non-corresponding data 204, 205, 206, 207, and 208. These significantly unaligned sets of data and tasks results from attempting to use the same order that was used for assigning the data 201-208 for assigning the tasks 211-218 while skipping over the CPC 323, i.e., assigning task 1 211 to APC 221-1, task 2 212 to APC 221-2, task 3 213 to APC 221-3, skipping over the CPC 323 due to its limited ability or inability to execute the advanced tasks, and continuing to assign task 4 214 to APC 221-1, task 5 215 to APC 221-2, task 6 216 to APC 221-3, again skipping over CPC 323, assigning task 7 217 to APC 221-1, and assigning task 8 218 to APC 221-2. Using this order of assignment, for example, task 5 215 is assigned to APC 221-2 while the data required by task 5 215, i.e., data 5 205, is assigned to HBM 226-1, and thus requires off-chiplet remote traffic between HBM 226-1 and APC 221-1. As five instances of non-corresponding data, i.e., data 204, 205, 206, 207, and 208, result from this order of assigning tasks, it is desirable to identify more efficient methods and orders of assigning tasks to minimize instances of non-corresponding data and thus minimize off-chiplet remote traffic between APCs and CPCs.

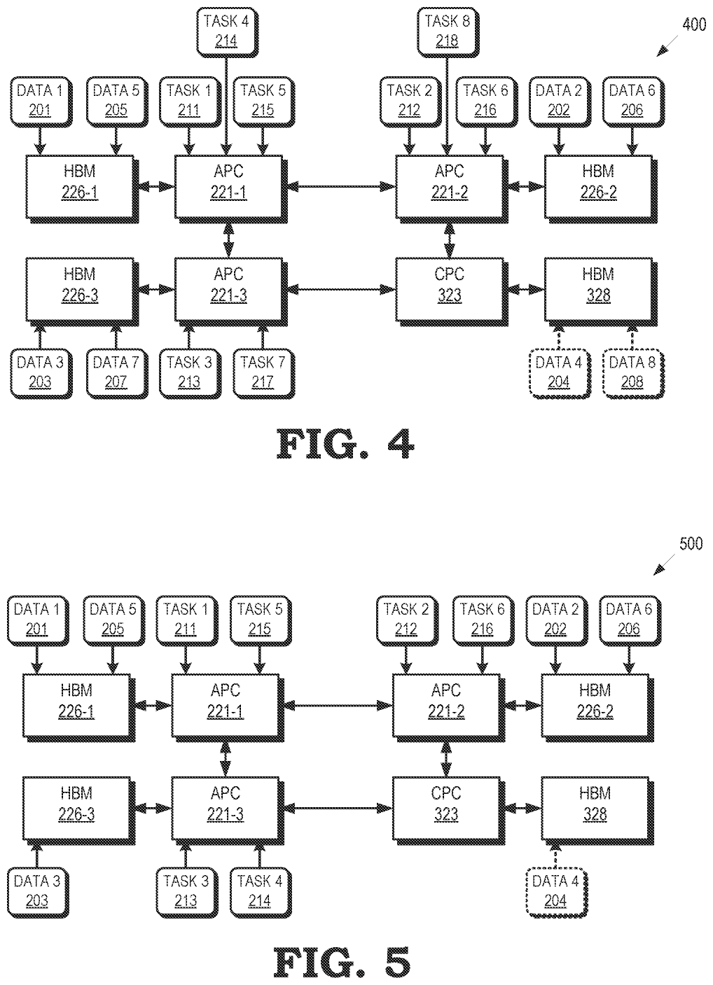

FIG. 4 is a block diagram 400 illustrating an example of efficient task assignment in a heterogeneous multi-chiplet processor according to some implementations. In the example of FIG. 4, rather than using an identical order of assignment for the tasks 211-218 and the data 201-208, while the data 201-208 is still assigned to HBMs 226 and 328 in sequential order, the tasks 211-218 are assigned to the plurality of APCs 221 to optimize, e.g., maximize, correspondence between the data 201-208 associated with the tasks 211-218 that is assigned to the HBMs 226 associated with the plurality of APCs 221 and the tasks assigned to the plurality of APCs 221. For example, it will be appreciated that, in FIG. 4, the data 201-208 is assigned to the HBMs 226 and 328 identically to how the data 201-208 is assigned to the HBMs 226 and 328 in FIG. 3, e.g., data 1 201 and data 5 205 are assigned to HBM 226-1, data 2 202 and data 6 206 are assigned to HBM 226-2, and so on. However, as explained further hereinbelow, rather than assigning the tasks 211-218 in the same order that the data 201-218 is assigned, the order in which the tasks 211-218 are assigned to the APCs 221 involves sequentially assigning a first set of the tasks 211-218 to the plurality of APCs 221 while skipping at least one task that would be assigned to the at least one CPC 323 if the CPC 323 were included in the applied order of assignment.

Notably, similar to the above description of “order” and “assignment order,” “skipping” in this context does not necessarily indicate any sort of timing but rather a feature of an algorithm. That is, in some implementations, “skipped” tasks are not necessarily “skipped over” in a practical timing sense while the tasks are actually being assigned, but their position within the assignment order of the algorithm is considered to be “skipped,” as described further hereinbelow. Subsequently, the at least one task that would be assigned to the at least one CPC 323 if the CPC 323 were included in the applied order of assignment is sequentially assigned to the plurality of APCs 221 after sequentially assigning the first set of the tasks. Similar to the discussions of “order” and “skipping” above, the term “after” does not necessarily imply that the assignment will occur after assigning other tasks in a chronological sense, but rather that the algorithm assigns tasks that were skipped in the algorithm “after” the other tasks in the sense that they are assigned last in the assignment order or pattern, regardless of when the assignments actually occur.

As shown in FIG. 4, task 1 211 is assigned to APC 221-1, task 2 212 is assigned to APC 221-2, and task 3 213 is assigned to APC 221-3. However, as task 4 214 would be assigned to the CPC 323 if the CPC 323 were included in the applied order of assignment, task 4 214 is skipped. Accordingly, after skipping the CPC 323 due to its inefficiency or inability to process advanced or highly parallel tasks, task 5 215 is assigned to APC 221-1, task 6 216 is assigned to APC 221-2, and task 7 217 is assigned to APC 221-3. Here again, as task 8 218 would be assigned to the CPC 323 if the CPC 323 were included in the applied order of assignment, task 8 218 is skipped. Now that all of the tasks 211-218 have either been assigned or skipped, in some implementations, the tasks that would be assigned to the at least one CPC 323 if the CPC 323 were included in the applied order of assignment, i.e., skipped tasks, are sequentially assigned to the plurality of APCs 221 after sequentially assigning the first set of the tasks. That is, task 4 214 is assigned to the next APC in order, i.e., APC 221-1, and task 8 218 is assigned to the next APC in order, i.e., APC 221-2, as shown in FIG. 4. In some implementations, rather than assigning tasks that would be assigned to the at least one CPC 323 if the CPC 323 were included in the applied order of assignment, i.e., skipped tasks, sequentially to the plurality of APCs 221 after sequentially assigning the first set of the tasks, the skipped tasks are assigned to the plurality of APCs evenly without reference to the sequential assignment of the first set of the tasks. For example, task 4 214 is assigned to a first APC, e.g., APC 221-2, without reference to the assignment of the last of the first assigned tasks, e.g., task 7 217 being assigned to APC 221-3, and task 8 218 is assigned to the next APC in order, i.e., APC 221-3, or a different APC out of order, e.g., APC 221-1. In some implementations, assignment of “skipped” tasks is determined by stepping through the APCs 221 in sequence, but in any desired order (e.g., APC 221-1, APC 221-2, APC 221-3; or APC 221-3, APC 221-2, APC 221-1; or otherwise), and assigning the skipped tasks to the APCs 221 by performing a modulo operation based on the number of APCs 221 in the GPU 115 and the number of “skipped” tasks, e.g., in a “Z” or round robin order independently from the assignments of the first assigned tasks. In some implementations, the “skipped” tasks are assigned to the APCs 221 in order to balance a total number of tasks assigned to each of the APCs 221 such that the tasks are at least approximately evenly spread across the APCs 221.

As illustrated in FIG. 4 and indicated by dashed lines, by using the ordering algorithm utilized in FIG. 4 and described above, the amount of non-corresponding data has been reduced from the five blocks of non-corresponding data in FIG. 3, i.e., data 204, 205, 206, 207, 208, to only two blocks of non-corresponding data in FIG. 4, i.e., data 204 and 208. As every other set of data and tasks are assigned to corresponding sets of APCs and HBMs (e.g., task 1 211 is assigned to APC 221-1, which corresponds to and/or shares a chiplet with HBM 226-1, which stores data 1 201, the data required for executing task 1 211) and only task 4 214 and task 8 218 will require off-chiplet remote traffic (i.e., to retrieve the corresponding data 4 204 and data 8 208 stored in HBM 328), the ordering algorithm utilized in FIG. 4 demonstrably minimize instances of non-corresponding data, and thus requires lower energy per bit and/or provides lower latency compared to the ordering algorithm utilized in FIG. 3 (i.e., identical ordering between the tasks 211-218 and data 201-208).

FIG. 5 is a block diagram 500 illustrating another example of efficient task assignment in a heterogeneous multi-chiplet processor according to some implementations. In the example of FIG. 5, only six sets of tasks 211-216 and data 201-206 are assigned. Although it will be appreciated that an identical assignment order of the data 201-206 is utilized as that of FIG. 4, e.g., data 1 201 is assigned to HBM 226-1, data 2 202 is assigned to HBM 226-2, and so on, task 4 214 is assigned to APC 221-3 in FIG. 5 rather than APC 221-1, despite the same algorithm being used as in FIG. 4. As shown in FIG. 5, after assigning task 3 213 to APC 221-3, task 4 214 is skipped as described above, task 5 215 is assigned to APC 221-1, and task 6 216 is assigned to APC 221-2. As all the tasks have been assigned or skipped, the skipped task, i.e., task 4 214, is then sequentially assigned to the next APC in order, i.e., APC 221-3. As illustrated by the dashed lines, only data 4 204 is non-corresponding data, and so only task 4 214 will require off-chiplet remote traffic (i.e., to retrieve the corresponding data 4 204 stored in HBM 328).

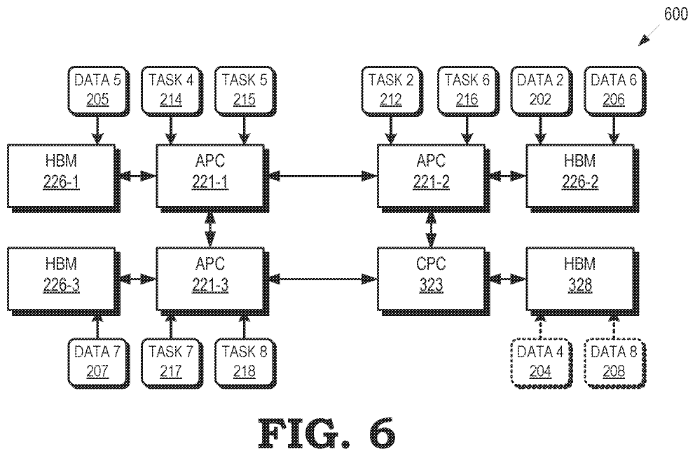

FIG. 6 is a block diagram 600 illustrating yet another example of efficient task assignment in a heterogeneous multi-chiplet processor according to some implementations. Referring back to FIG. 4, it will be appreciated that if task 1 211 and task 7 217 are cancelled, and therefore the data required for those tasks, i.e., data 1 201 and data 7 207, are no longer needed, the APC 221-2 will have three tasks assigned, i.e., task 2 212, task 6 216, and task 8 218, while the APC 221-3 will only have one task assigned, i.e., task 3 213. As shown in FIG. 6, in this scenario, in some implementations, task 8 218 is reassigned to APC 221-3 in order to balance the number of tasks assigned to each of the APCs 221.

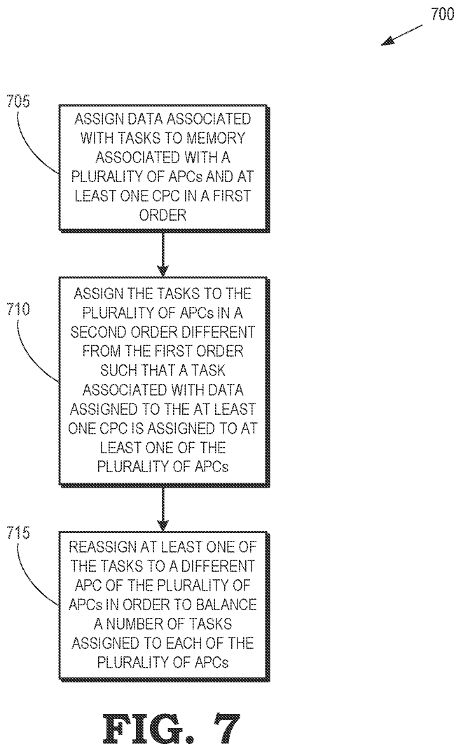

FIG. 7 is a flow diagram of a method 700 of providing efficient task assignment in heterogeneous multi-chiplet processors according to some implementations. In some implementations, the method 700 is executed by one or both of the GPU 115 and the scheduler 112 of the processing system 100 of FIG. 1. At block 705 of the method 700, a heterogeneous multi-chiplet processor, GPU, or a controller (such as the scheduler 112) in a heterogeneous multi-chiplet processor or GPU, such as the GPU 115 of FIG. 1, assigns data, such as the data 201-208 of FIGS. 4-6, associated with tasks, such as the tasks 211-218 of FIGS. 4-6, to memories associated with a plurality of APCs and the at least one CPC, such as the APCs 221 and CPC 323 of FIGS. 4-6, in a first assignment order. At block 710 of the method 700, a scheduler or controller in the GPU, such as the scheduler 112, assigns the tasks to the plurality of APCs in a second assignment order different from the first assignment order such that at least one task associated with data assigned to the at least one CPC is assigned to at least one of the plurality of APCs. For example, in some implementations, the second assignment order sequentially assigns a first set of the tasks to the plurality of APCs while skipping at least one task that would be assigned to the at least one CPC if the CPC were included in the second assignment order, and the at least one task that would be assigned to the at least one CPC if the CPC were included in the second assignment order is sequentially assigned to the plurality of APCs after sequentially assigning the first set of the tasks, as discussed further hereinabove in the examples of FIGS. 4 and 5. As also discussed further hereinabove in the examples of FIGS. 4 and 5, in some implementations, the second assignment order assigns tasks to the plurality of APCs to optimize correspondence between the data associated with the tasks that is assigned to the memories associated with the plurality of APCs and the tasks assigned to the plurality of APCs. At block 715 of the method 700, the scheduler reassigns at least one of the tasks to a different APC of the plurality of APCs in order to balance a number of tasks assigned to each of the plurality of APCs.

In some implementations, the apparatuses and techniques described above are implemented in a system including one or more integrated circuit (IC) devices (also referred to as integrated circuit packages or microchips), such as the GPU 115, the APCs 121, 122, and 221, the scheduler 112, the HBMs 126, 127, 128, and 328, and the method 700 described above with reference to FIGS. 1 and 4-7. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An apparatus comprising:
a multi-chiplet processor comprising:
a plurality of parallel processing chiplets (PPCs) to process tasks;
a central processing chiplet (CPC), wherein the multi-chiplet processor is to assign data associated with the tasks to memories associated with the plurality of PPCs and the CPC in a first assignment order; and
a scheduler to assign the tasks to the plurality of PPCs in a second assignment order different from the first assignment order such that a task associated with data assigned to the CPC is assigned to at least one of the plurality of PPCs.

2. The apparatus of claim 1, wherein the first assignment order sequentially assigns the data to the memories associated with the plurality of PPCs and the CPC.

3. The apparatus of claim 1, wherein the second assignment order sequentially assigns a first set of the tasks to the plurality of PPCs while skipping a task that would be assigned to the CPC if the CPC were included in the second assignment order.

4. The apparatus of claim 3, wherein the task that would be assigned to the CPC if the CPC were included in the second assignment order is sequentially assigned to the plurality of PPCs after sequentially assigning the first set of the tasks.

5. The apparatus of claim 1, wherein the second assignment order assigns tasks to the plurality of PPCs to optimize correspondence between the data associated with the tasks that is assigned to the memories associated with the plurality of PPCs and the tasks assigned to the plurality of PPCs.

6. The apparatus of claim 1, wherein the scheduler is to reassign a task to a different PPC of the plurality of PPCs to balance a number of tasks assigned to each of the plurality of PPCs.

7. The apparatus of claim 6, wherein the scheduler is to reassign the task to a different PPC of the plurality of PPCs when a different one of the tasks is cancelled.

8. An apparatus comprising:
a multi-chiplet processor including a scheduler, a plurality of parallel processing chiplets (PPCs) to process tasks, and a central processing chiplet (CPC), wherein:
the scheduler assigns the tasks to the plurality of PPCs such that a task associated with data assigned to the CPC is assigned to at least one of the plurality of PPCs.

9. The apparatus of claim 8, wherein the processor sequentially assigns data to memories associated with the plurality of PPCs and the CPC.

10. The apparatus of claim 8, wherein the scheduler sequentially assigns a first set of the tasks to the plurality of PPCs while skipping a task that would be assigned to the CPC if the CPC were included in the sequential assignment.

11. The apparatus of claim 10, wherein the task that would be assigned to the CPC if the CPC were included in the sequential assignment is sequentially assigned to the plurality of PPCs after sequentially assigning the first set of the tasks.

12. The apparatus of claim 8, wherein the scheduler assigns tasks to the plurality of PPCs to optimize correspondence between data associated with the tasks that is assigned to memories associated with the plurality of PPCs and the tasks assigned to the plurality of PPCs.

13. The apparatus of claim 8, wherein the scheduler reassigns a task to a different PPC of the plurality of PPCs in order to balance a number of tasks assigned to each of the plurality of PPCs.

14. The apparatus of claim 13, wherein the scheduler reassigns the task to a different PPC of the plurality of PPCs when a different one of the tasks is cancelled.

15. A method of assigning tasks in a multi-chiplet processor including a plurality of parallel processing chiplets (PPCs) and a central processing chiplet (CPC), comprising:
assigning data associated with the tasks to memories associated with the plurality of PPCs and the CPC in a first assignment order; and
assigning the tasks to the plurality of PPCs in a second assignment order different from the first assignment order such that a task associated with data assigned to the CPC is assigned to at least one of the plurality of PPCs.

16. The method of claim 15, wherein the first assignment order sequentially assigns the data to the memories associated with the plurality of PPCs and the CPC.

17. The method of claim 15, wherein the second assignment order sequentially assigns a first set of the tasks to the plurality of PPCs while skipping a task that would be assigned to the CPC if the CPC were included in the second assignment order.

18. The method of claim 17, wherein the task that would be assigned to the CPC if the CPC were included in the second assignment order is sequentially assigned to the plurality of PPCs after sequentially assigning the first set of the tasks.

19. The method of claim 15, wherein the second assignment order assigns tasks to the plurality of PPCs to optimize correspondence between the data associated with the tasks that is assigned to the memories associated with the plurality of PPCs and the tasks assigned to the plurality of PPCs.

20. The method of claim 15, further comprising reassigning a task to a different PPC of the plurality of PPCs in order to balance a number of tasks assigned to each of the plurality of PPCs.
